(19) United States
(12) Patent Application Publication
(10) Pub. No.: US 2004/0186770 A1
(43) Pub. Date: Sep. 23, 2004

(54) Customer loyalty development, management and reward platform system

(76) Inventors: Brian Pettit, Glengarriffe (IE); Kevin Pettit, Dublin (IE)

Correspondence Address: MCDONNELL BOEHNEN HULBERT & BERGHOFF LLP, 300 S. WACKER DRIVE, 32ND FLOOR, CHICAGO, IL, 60606, US

(21) Appl. No.: 10/451,760

(22) PCT Filed: Dec. 21, 2001
(86) PCT No.: PCT/IE01/00162

(30) Foreign Application Priority Data
Dec. 22, 2000 (IE) S2000/1075

(51) Int. Cl. G06F 17/60

(52) U.S. Cl. 705/14

(57) ABSTRACT

A customer loyalty system is described. This system provides an action processor which is adapted to analyse and process transaction concucted by a customer. The processing of these transactions effects an updating of that customer account in a real time environment.

### FIELD OF INVENTION

The invention relates to customer loyalty development, management and reward systems and in particular to electronic, wireless and/or computer based systems adapted to interface with a customer loyalty database.

### BACKGROUND TO THE INVENTION

In today's rapidly evolving commercial environment the success of the vendor/broker of a product or service is predicated on developing, managing and rewarding customer loyalty. The development of such loyalty is based however on utilising knowledge of the consumer to enhance vendor/broker offerings and to offer rewards that are meaningful, of value, and relevant to consumers desires. Loyalty and Customer Relationship Management systems are well known particularly within the retail trade.

Typically a customer is rewarded for continued patronage/usage of a particular retail outlet, brand retail chain, or an associated group of retailers. This reward may be in the form of money back vouchers on future purchases, special offers on goods or services, or a scheme of points measured against purchases or continued usage which can then be accumulated and later redeemed for special gifts on offer.

In known systems the customer must first register as a member of the loyalty reward scheme and is issued with a means of identification, typically a magnetic swipe card. A database entry is established for the customer and any purchases made by the customer at designated outlets are used to update that customer's profile in the database. When effecting a transaction at any of the participating outlets the customer presents the swipe card which effects a transfer of the associated loyalty points resulting from that transaction to the customer's profile. The retailer advises the customer as to his current balance of loyalty points at predetermined time intervals, and the customer can choose to redeem the loyalty rewards at any time. Known systems have used a paper transaction between both customer and retailer—for example, the customer is notified by a postal communication from the retailer and the customer redeems the reward by effecting a paper interaction with the retailer or the retailer's agent.

In a typical loyalty card system, the information on a customer's purchase history gathered over a quarterly period is sent from the retailer's database to a fulfilment house and transformed or converted into discount/money off vouchers, which are in turn sent out to the customer for his or her redemption. As nearly every retailer offers such loyalty systems, it is common to find customers with a number of loyalty cards. Current systems tend to shift gratification downstream, with rewards being distributed at a later date. Such gratification tends to be of an insufficiently compelling value, i.e. typically no more than 1% of accumulated transaction value. Because of a low perceived value attaching to the rewards, no real genuine loyalty exists and no differentiation is afforded to different retailers for implementing such systems. Nevertheless, many retailers are hoping that customer loyalty can be used as a key tool for increasing business profitability through increasing customer retention, the average shopping basket size and the frequency of visits. However, with the most common loyalty systems In use at present, the cost to retailers is at least 2% of sales per annum, with little or no real benefit arising to the retailer in return for these outlays.

Many efforts have been made to improve customer loyalty systems, as evidenced by representative prior art described below. WO-A-00/42941 describes a method for analysis of customer buying behaviour and patronage, using offers of lower prices on products to reward and encourage back existing customers.

FR-A-2,760,549 describes a loyalty system transforming discounts awarded when items have been purchased into cash in a customer's savings account. This supposedly enables saving while consuming, but even cash reward systems suffer from an inherently low perceived value in relation to the amount spent.

WO-A-98/40834 discloses a similar system for consumption related financial transactions. Transaction details are transferred from the point of sale to the fulfilment house and the discount received by the customer is transferred into a savings account in the name of the consumer in a designated financial institution.

FR-A-2,754,082 describes a scheme for managing customer information through the use of a customer smart card. The card is swiped at each purchase, the customer and his/her purchasing behaviour are identified and updated on a periodic basis.

WO-A-99/43168 describes a loyalty scheme, whereby without the use of a plastic swipe card, the customer accumulates points which he/she can then access through the use of a radio receiving device, such as a pager, and view the current balance of points accrued.

EP-A-0,999,690 describes a loyalty system for use in the mobile phone service provider industry to reduce churning. This operates by monitoring the level of calls made in a certain time period, and through the use of this data and predetermined demographic variables, customers at risk of churning may be identified and contacted by phone, e-mail or text message offering them a better contract.

WO-A-99/50733 discloses a loyalty system whereby the customer is rewarded progressively according to the number of visits made to the retailer's establishment. The more the customer returns to the establishment, the more discounts the customer receives. If a discount is not used within a certain predetermined time period, the customer loses the discount. If the customer uses the discount within this period, the next discount is increased to a predetermined level.

GB-A-2,304,625 discloses a combined telephone and retail outlet loyalty points card. The card comprises one or more magnetic strips for storing information representative of credits accumulated through use of the card at a retail outlet which can be used to pay for telephone charges. The loyalty card is combined with a phone card and is useable in a call box or telephone accepting phone cards. The value on the card is rechargeable by payment or by cash value credited by the loyalty reward scheme.

U.S. Pat. No. 5,774,870 describes a fully integrated, on-line interactive frequency and award redemption program. A user may access the program on-line and may browse a product catalogue for shopping. The user may electronically place an order, upon which the program automatically checks the user's credit and electronically issues a purchase order to the supplying company. The program also calculates award points, updates the award account of enrolled users, and communicates that number of awarded points to the user. Enrolled users may browse through an award catalogue and electronically redeem an amount of accumulated points towards an award. The program then electronically places an award redeeming order with the fulfilment house and updates the user's award account.

WO-A-96/21848 relates to a “telecommunications reward method”, where the customer is given free airtime based on the use of the system

U.S. Pat. No. 6,000,608 discloses an invention relating to debit card systems, both bank issued and non bank issued, and more particularly to a multifunction card system that can be accessed by a variety of standard point-of-sale devices, by phone, by fax or over the internet.

None of the above identified disclosures point to a loyalty system which is truly compelling for the customer or consumer in terms of instantly delivering the reward, special offer or relevant information at the time of purchase. Furthermore, the known systems are not adapted to entice the customer to use of the system through rewards of higher perceived value and which the consumer can redeem in an easy, user friendly manner at any time and in any location etc. It is apparent that there is a requirement for a loyalty system which increases the certainty that the loyalty of customers/consumer can be obtained, maintained and improved. There is a further need for a system and method which reduces the overall cost of provision and maintenance of the system, and which leverages the true marketing power of the customer database, thereby converting what is often a cost centre into a profit centre for vendors/brokers.

### SUMMARY OF THE INVENTION

The present invention has been made in consideration of the above described problems and needs and has particular application to a system which allows vendors/brokers to obtain, retain and accurately customers while simultaneously increasing their loyalty, purchase frequency and purchase volume on a one-to-one relationship in a digital and/or wireless environment.

The present invention provides a system and method that enables the vendors/brokers to implement customer loyalty, retention and marketing techniques in a digital and/or wireless environment. These techniques allow customers to be identified and profiled against predetermined and evolving criteria and to be rewarded for their loyalty to the vendors/brokers in a more effective, valuable and tangible way on a differentiated basis. It also enables the vendors/brokers to implement a real time reward system which can also deliver digital rewards, products and services.

The present invention is desirably implemented through the use of mobile phone (wireless) and mobile internet technology and existing electronic point of sale (EPOS) systems (or their counterparts), and is executed through an existing or provided mobile telephone or internet enabled mobile device, (or equivalent hand held internet accessible device). These techniques are suitable for mobile phones mobile devices with internet accessibility and interactivity, and are also applicable to short message service (SMS) or USSD systems. According to one aspect of the present invention, the present invention discloses a method and system for making digital rewards to the customer on the basis of pre-determined levels based on purchase volume, frequency, and demographic variables to reward customers for their continued patronage of the retailer's business. These customers are identified at the cash counter when paying for their products, through the use of for example a loyalty swipe card. The details of the customer's purchases are sent through the digital reward system. This system calculates the amount of digital reward units due to the customer, based on the aforementioned predetermined levels. The digital reward units are transmitted to the customer's loyalty account, which is accessible through the use of the customer's mobile device or through any internet accessible device. For example, if the customer spends $100, the customer is rewarded, in a near real-time period, with for example $2.50 worth of digital reward units which are stored in the customer's loyalty account which they can access using their mobile device or alternative internet accessible device.

According to another aspect of the present invention, the customer who has accumulated digital reward units in their digital loyalty account may choose among a number of options as to where to transfer those digital reward units and as to how to use them. Options available to the customer may include;

a) the ability to save their digital reward units for redemption at a later time period,

b) transfer some or all of the balance of those units into a pre-paid communications account,

c) transfer some or all of those units into their utilities accounts,

d) transfer some or all of those units into their e-bank account (or e-purse),

e) purchase digital products (such as downloading music or films) and/or

f) transfer some or all of those units into any other account capable of affording value to those digital reward units transferred.

The communications accounts is preferably selected from one or more of the following:

a pre-paid landline telephone account,

a pre-paid mobile telephone account,

an internet account.

Accordingly, the customer is rewarded with Digital Reward Units, the customer choosing what form that reward will take, depending on into which of the above mentioned accounts (i.e. a) through f) above) the customer decides to transfer his or her Digital Reward Units.

According to another aspect of the present invention the customer may chose to top-up/pay money toward any of the above mentioned accounts. For example, when paying for their other products the customer may choose to increase the balance of their pre-paid mobile phone account by $20 etc. by paying that sum while paying for their other purchases. This sum Is automatically credited to the customer's mobile phone account, incrementing their balance account, and allowing the customer to continue to use their mobile telephone.

According to still another aspect of the invention event triggered email or SMS messages may be used by the vendors/brokers, service provider, producer and/or wholesaler arising when specific predetermined criteria relating to the detail of any input data (i.e. retail transaction, stock acquisition etc.) is met. For example, if a customer buys a certain brand for 6 weeks and then switches to a competing brand, the producer of the 1^{st} brand might send an email or alternative electronic message to the customer's mobile device informing the customer that if they start buying the 1^{st} brand again, they will be rewarded with increased digital reward units or money off that product. In another example if new stocks of a particular merchandise, digital product or service become available, the vendors/brokers may send an SMS/email or computer generated voice message to the consumer's mobile device advising of availability, price and location. In another example customers who utilise internet purchasing may designate their loyalty provider, typically being a specific retail outlet as the delivery point and when delivery is effected and recognised by the system it automatically informs the customer.

According to a preferred embodiment the system of the present invention comprises:

at least one data input processing system adapted to be in electronic contact with a data input recording device, the data input processing system adapted to receive information relating to specific actions from the Input recording device and to process this information into one or more action output modules, the action output modules having associated definable parameters,

an action processing system located remotely from the at least one data input processing system, the action processing system adapted to electronically receive action output modules from one or more remotely locatable data input processing systems, and to process these action output modules according to their associated defined parameters, and

a client interface system adapted to be in communication with one or more remotely locatable clients, the interface system effecting communication between the action processing system and the client so as to enable a client to receive information relating to the specific retail transaction conducted and to interrogate the action processing system with regard to the results of the processed action output modules.

The data input processing system is typically adapted to process retail transactions conducted by customers at a retail outlet.

The data input recording device is typically an electronic point of sale device at retail out outlets, an ERP system, a news/wire service or the like.

The data input processing system is preferably co-locatable or embedded with the data input recording device, the co-location enabling real-time communication between the data input processing device and the data input recording device so as to effect a formation of a first set of action modules resulting from individual data inputs and the formation of a second set of action modules resulting from the summation of total data inputs effected at one time.

The data inputs are typically transactions conducted by a consumer at a retail outlet.

The individual actions are typically, but not exclusively individual sales Item transactions whereas the summation of total data inputs may for example represent the sum of individual sales items.

The individual action output modules are typically, but not exclusively, related to specific predetermined events, transactions or information such that such events formulate action output modules which may effect a prompting or alerting of a consumer with regard to specific promotions, availability of products or services or other value to be gained.

This prompting of a customer may be effected immediately such as at the time of a retail purchase or at a later date. Typically, where the prompting is conducted at the time of the initiating action, the action module associated with that prompting is processed at the data input processing system; alternatively the action module is processed at the action processing system.

Alternatively, the individual action modules may be related to a monetary payment effected by the customer at the data input or point of sale device so as to increment a digital account of that customer.

The digital account may desirably be selected from one or more of the following:

a pre-paid mobile telephone account,

a pre-paid land line telephone account,

a utility account relating to one or more utilities,

an electronic purse,

a digital download account relating to one or more entertainment channels, and/or

a gaming account allowing the user to gamble electronically.

The term “utility” is intended to include any type of service which is used by the public such as but not limited to an electricity or gas supply or a train service.

The total action output modules typically effect a creation of digital reward units, the number of digital reward units being related to the total value of the transactions conducted.

The digital reward units are preferably incremented against the digital account of the specific customer, the incrementation being effected by the data processing server.

In a preferred embodiment the invention provides a system which effects an incrementation of a customer's pre-paid account in accordance with the customer's transactions at a retail outlet.

These and other features of the present invention will be better understood with reference to the following drawings.

### BRIEF DESCRIPTION OF THE DRAWINGS

FIG. 1 shows a system according to the present invention,

FIG. 1b shows a transaction analysis and reaction process (TARP) device structure,

FIG. 2 is a process flow showing the processing of transactions at a transaction processing server of the present invention,

FIG. 2a is a process flow showing the operation of a TARP client/server

FIG. 3 is a detailed process flow of the process of FIG. 2,

FIG. 4 is a process flow showing detailed operation of some of the processes associated with FIG. 3,

FIG. 5 is a top level process flow of the process of at a TARP server,

FIG. 6 is a detailed process flow of the processing of an action module,

FIG. 7 shows a portion of an internal structure of a TARP server detailing the payment of utility accounts, and

FIG. 8 is a process flow showing the use of the system of the present invention to provide a mobile phone service.

### DETAILED DESCRIPTION OF THE DRAWINGS

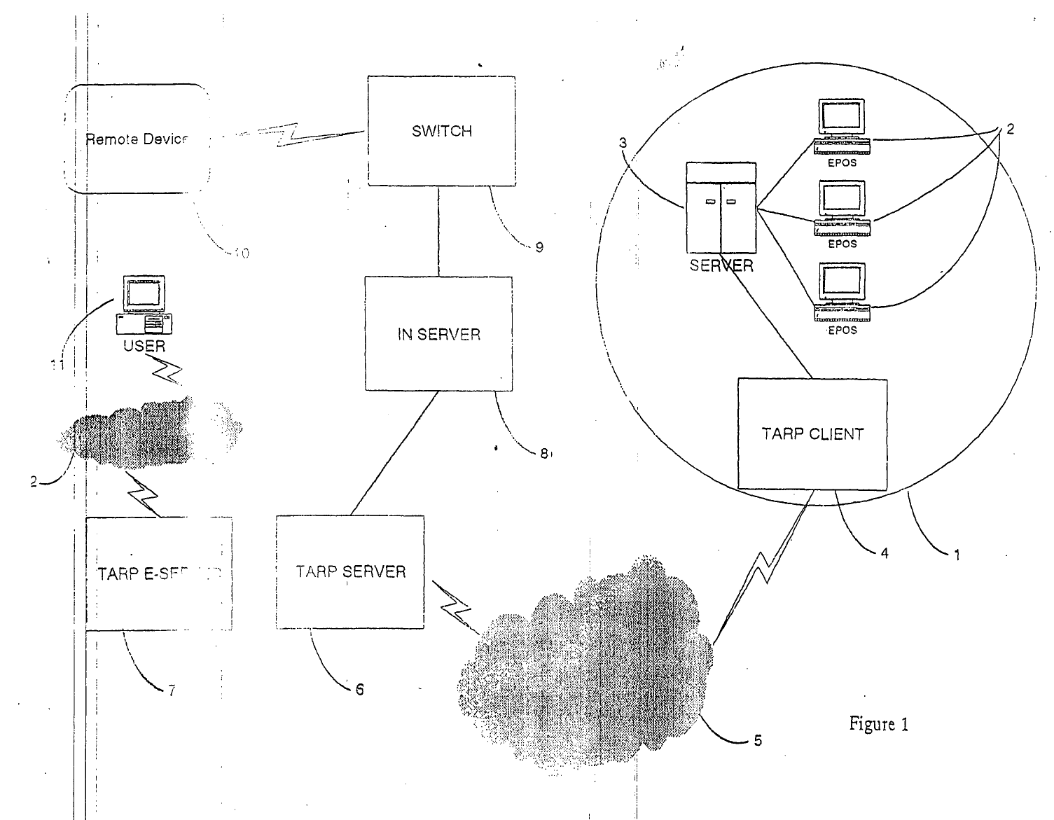

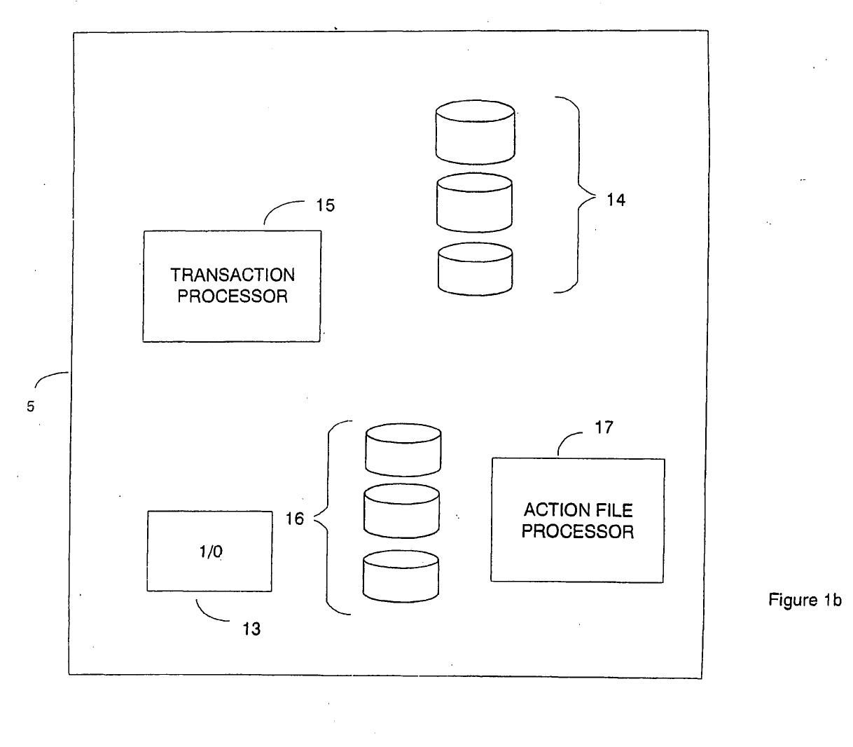

FIG. 1 shows an example of a network system according to the present invention, and is specifically designed for use in a retail environment. This system, it will be appreciated, is exemplary of the type of application environment where the system and method of the present invention may be utilised, and it is not intended to limit the application of the present invention to such environments. The system is adapted to interface with transactions conducted by a customer at a retail outlet and to update that customers profile or an associated digital account of that customer with credits dependent on the volume and nature of the transactions conducted by the customer at the retail outlet.

A customer or consumer, having a mobile device such as a mobile or radio telephone, presents himself to a retail outlet 1 having at least one data input recording device such as an electronic point of sale (EPOS) device 2 linked to an EPOS server 3. In the course of the transaction the details of the specific transactions conducted by the customer at the EPOS device 2 are updated to the EPOS server 3. The EPOS server 3 collects and stores customer profile information and details regarding the purchases made during that transaction. A transaction analysis and reaction process (TARP) client 4 or action/data input processing (AIP) server is provided by the system of the present invention, details of which are shown in FIG. 1a, and is adapted in one embodiment to be in communication with the EPOS server 3.

The TARP/AIP client 4 is updated via a communications port 13 with the same information of the transaction process that the EPOS server 3 is updated with from the EPOS devices 2. In an alternative embodiment, not shown, once the TARP/AIP client has been installed all the information that was previously stored on the EPOS server 3 is mirrored on the TARP client 4 and the TARP client 4 can be adapted to be in direct communication with the individual EPOS devices 2.

The TARP/AIP client 4 associates the specific transactions with an identified customer from a stored database of customer profiles 14 and processes the transactions conducted at the EPOS devices 2, in a transaction processor module 15, into one or more action files 16. Each action file 16 is adapted to effect a specific action depending on the transaction that initiated the formation of that action file. Depending on the specific action, individual action files may be processed into actions using an action processor module 17 located at the TARP client 4, or may be communicated, over a network 5, to a remotely locatable action/data output processing server or AOP server 6. The processing of the action file may effect an updating of the specific customers associated digital account or may effect the transmittal of customer related information to that specific customer.

The structure of the TARP/AOP server 6 is similar to that of the TARP/AIP client 4, in that it is adapted to associate incoming action files with their respective originating customer and to update the customer profile based on the processing of the action files. The TARP server 6 processes or further processes in situations where some processing has been effected on the TARP client 5, the action files in accordance with their defined parameters so as to update a specific customer's digital account or to transmit action file activated information to the customer. Interaction between the TARP server 6 and a remotely located customer is achieved over known communication networks such as but not limited to mobile networks, the internet etc.

In a preferred embodiment of the present invention the conducting of actions or transactions by the customer at the vendors/brokers premises or retail outlet effects the granting of a “reward” to the specific customer in the form of an incrementation to that specific customer's mobile telephone pre-paid account or other electronic account. In such a situation the processing of the action files by the AOP server 6 effects a transmittal of information to a telephone intelligent network (IN) server 8 relating to the value of the incrementation of the specific account. The individual account is updated in accordance with standard telephony procedures and a mobile phone user 10 interfaces with the account over a switch 9. In effect the system of the present invention has effected an incrementation of the identified customer's mobile telephone or other electronic account based on the value and volume of transactions conducted or amount tendered by the customer at a retail outlet. This incrementation is effected over an electronic network and requires no customer interface once the retail transaction has been conducted.

A customer or client may also interact with the TARP/AOP server 6 from a home computer or equivalent 11 to examine his specific digital account and/or to update information relating to that account. Such interaction may be effected over standard internet networks 12, and the interface may be provided using a TARP e-server 7. In an alternative embodiment, a customer or client may interact with the TARP/AIP server 6 from his/her mobile phone using technology such as short messaging service (SMS) or the like, to examine his specific digital account and/ or to update information relating to that account.

As detailed above with specific reference to updating a mobile telephone account, the completion of a transaction by the customer at a retail outlet effects an updating of a customer specific associated database account with one or more digital reward units. The choice of accounts are typically chosen from one or more of the following:

a) e-bank account wherein the digital reward unit is credited as a monetary addition to the account,

b) pre-paid telephone account, thereby enabling the user to supplement a telephone account,

c) one or more utility accounts including for example; electricity, gas, oil, telephone etc.,

d) entertainment account etc.

In a preferred embodiment of the present invention at least one of the action output modules are related to a customer mobile telephone account and the processing of the specific telephone action module by the TARP server effects an updating of that specific customers pre-paid telephone account. In such specific processing the AOP server 6 transmits information relating to the incrementation of the account to a mobile telephone intelligent network (IN) server 8 which interacts with a client subscriber to that specific network via a mobile telephone switch 9. It will be appreciated that in such circumstances that decrementation of the customers mobile phone account, on the intelligent network server 8, resulting from use of the mobile telephone will be communicated to the TARP server 6 so that a customer interfacing with the TARP server to examine his customer account will be updated as to the value of the account.

The transmission of action output module activated information to the customer may typically be achieved using known SMS technology to the customers hand held device. Alternatively, the customer may be updated by means of event triggered email.

In addition to using a reward system to supplement these accounts the user may alternatively simply make use of the retail outlet to directly credit the specific accounts. For example, the customer wishes to top-up a prepaid mobile account. He/She proffers amount plus identifier (loyalty card or mobile phone number) to cashier 2. The transaction is processed at the TARP/AIP client 4. The transmission of such incrementation information is via SMS over USSD in order to effect a real-time incrementation of the customers account.

Using their mobile telephone or standard internet protocols the user may access one or more of their established accounts, thereby enabling them to view balances, transfer funds or reward units from one account to another or purchase one or more available digital products. By the term digital product is meant any electronically storable or activatable product that has a value associated therewith.

As will be appreciated the system of the present invention, in one aspect, provides an electronic means of effecting a loyalty reward system. By enabling an interaction between a database associated with a specific individual's mobile telephone with known retail database associated with customers shopping profiles and allocated rewards it is possible to more directly manage the targeting of specific products ranges and the customer is afforded the opportunity to visually and interactively assess the digital reward units that they have accrued, and use these rewards as they see fit in a variety of accounts accessible through their internet accessible mobile device.

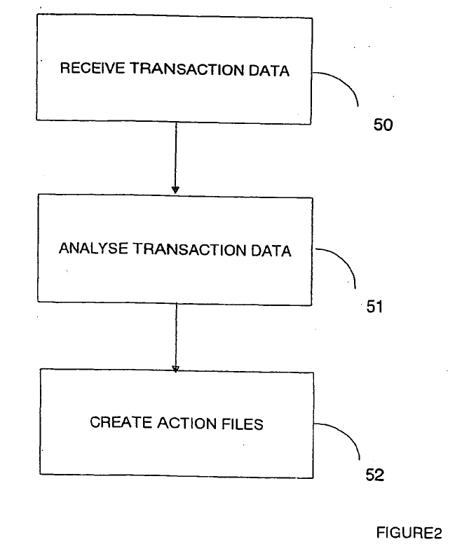

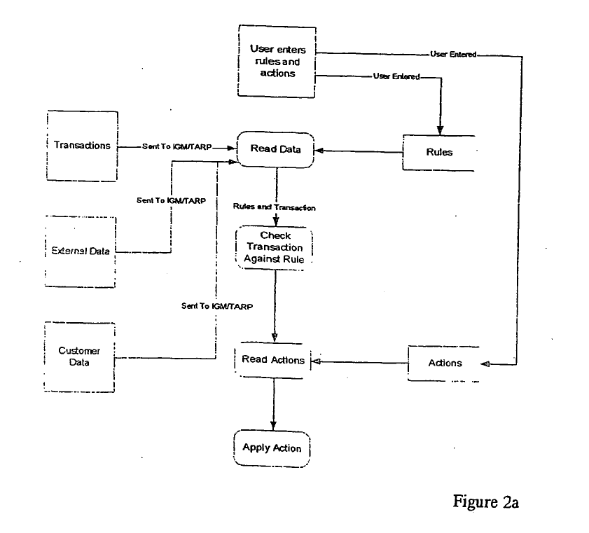

FIG. 2 is an outline of a TARP/AIP client server processing engine. The processing engine receives an input stream of transactions, typically in XML or some alternative platform independent format, applies predefined rules and produces a user-defined output if the criteria for satisfaction of the rules are met. The data is analysed on a per transaction basis. The TARP client 4 receives the same information as the EPOS server 3 relating to on-going transactions being conducted by customers at one or more EPOS devices 2 (Step 50). The TARP client 4 analyses the raw transaction data (Step 51), and associates related data into a series of action output modules (Step 52). These action output modules have associated parameters relating to the customer profile and what action Is to be conducted once the action output modules are processed. The TARP client maintains a mirror image of the customer profile that were previously uniquely stored at the EPOS server and operates independently of the EPOS server.

FIG. 2a is an outline of the operation of a TARP client/server processing engine. As detailed previously the processor takes an input stream of transactions, applies predefined rules and produces a user-defined output if the criteria for satisfaction of the rules are met. The data is analysed on a per transaction level. Preferably the processing is platform independent. There are four main elements to the engine:

i. input of data

ii. input of rules for processing of data

iii. application of rules onto data

iv. output of action/ data based on (iii)

The operator or user of the system enters a series of rules and actions into the processor, the rules defining how specific transactions will be processed and the necessary criteria to be met by the data read before an action is to be applied. Rules can include for example, customer variables—historical data etc., external data, previous rule values and any known data supplied for analysis or any combination thereof. An example of a rule would be:

For the record read

If field a is equal to 10 and field b is not today and external data is 34f.

Actions on the other hand define what is to be done when the data matches a certain rule. These include, for example, that if a specific transaction is identified that the customer is to be credited with “X” number of reward units or if another transaction is identified that “X” is to be credited to a digital account. An action will be of a preset type—for example create, delete, send email, SMS, modify account etc. When the rule criteria is met by the analysed data the action will be applied according to its action type. The actions are storable within the TARP client/server and holds typically three fields:

A unique action identifier

a type identifier

a value to apply according to the type identifier.

For example: Action 1 states that we need to modify record 200 for the data we have just read and increment its value to +1. If record 200 does not exist then we need to create it and assign a value of 1.

Information relating to the specific transactions, the customer performing the transaction and any other external data information is then input to the system processor engine. The specific transactions are then read against the rules in the engine to ascertain whether the data is suitable to apply the actions defined within the system. If the data matches the rule criteria it is matched against the relevant action(s) which are then applied.

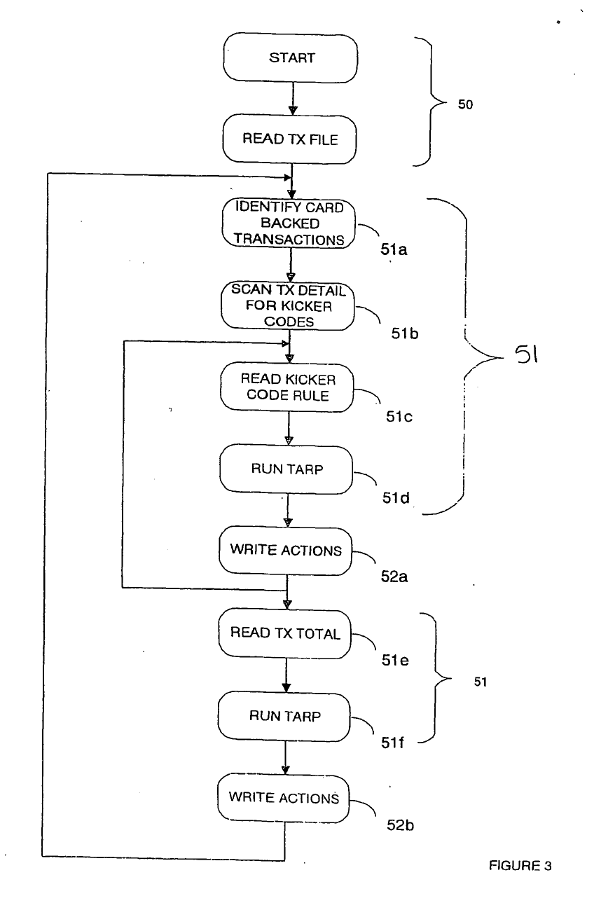

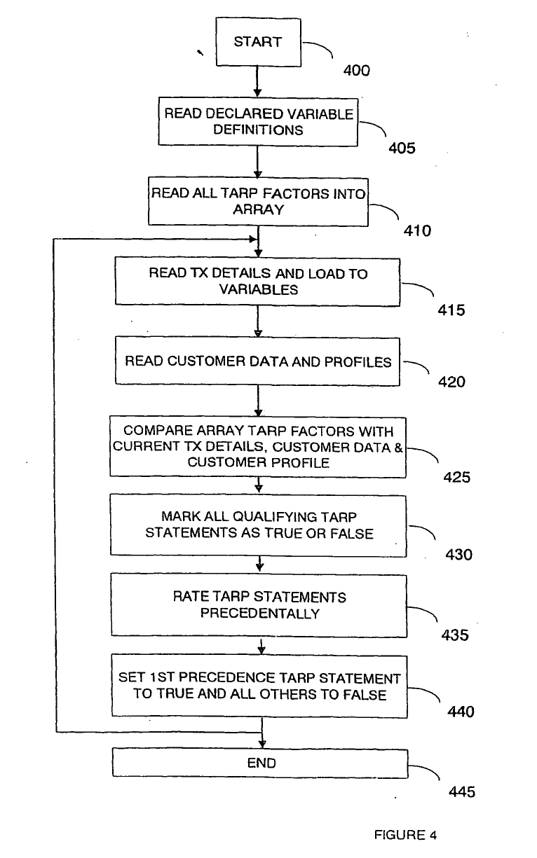

FIG. 3 is a detailed process flow, outlining the processing of a specific consumer interaction at a EPOS device 2. Details of the on-going transaction are relayed to the TARP client where they are read (Step 50). The TARP client 4 analyses the transaction details (Step 51) which includes the following steps; the transaction details to examine whether they are associated with a predefined user, i.e. whether the user is a subscriber to the retailer loyalty scheme (Step 51a). Further analysis of the transactions is restricted to those users that are subscribers. The transaction details are then scanned for specific kicker codes which are related to the products on which analysis is to be conducted (Step 51b). The kicker code is correlated with a defined kicker code rule which details what action is to be conducted as a result of that kicker code being present within the transaction series (Step 51c). The TARP client then runs a transaction analysis and reaction process (TARP) (Step 51d), as detailed with reference to FIG. 4. Once the TARP process has been conducted on the specific transaction an action module is written (Step 52a). The process is repeated for all individual transactions relating to the customers interaction at the EPOS device 2. It will be understood therefore that the purchase by a consumer of a multiplicity of products may effect the formation of an associated multiplicity of action output modules. Once all the purchases or interactions between the consumer and the EPOS device 2 have been completed the EPOS client 2 effects a summation of the total transaction, which is forwarded to the TARP client where it is read (Step 51e). The TARP process is then re-run on that total transaction summation (Step 51f). A second action module is then created for the total transaction (Step 52b). It will also be appreciated that the formed action modules relating to a specific customer may be used to update the customer profile 14 as stored on the datastore. Such real-time updating of a customer profile enables the system of the present invention to react to and stimulate further promotions which may be relevant to that customer.

FIG. 4 details the process flow associated with a TARP process—detailed previously as occurring at Steps 51d and f. The TARP process is initiated (Step 400). All declared variable definitions are then read into an array (Step 405). This equates to defining allowable variables on which the system will conduct the processing. All the TARP factors are then also read into the array (Step 410). The transaction details are then associated with defined variables (Step 415), and the specific customer information and details—as determined from the subscriber database—are then loaded into the array (Step 420).

The TARP array factors are then compared with the current transaction details and the relevant customer information (Step 425). As a result of this comparison it is possible to mark all the relevant TARP factor as either True or False (Step 430): for example if the test requires the presence of a purchase of a tin of beans, the comparison between the TARP factor and the declared transaction details will return a true statement if beans have been purchased and a false statement if no beans have been purchased.

The TARP statements are then rated precedentally (Step 435), and then the first precedence TARP statement is set to true and all other statements to false. By equating the TARP statements are true or false and then rating them it is possible to identify if a plurality of possible rewards may be generated from this series of transactions. The operator of the reward system is then offered the opportunity of passing all rewards onto the customer or deciding—in situations where some “rewards” is rated as a higher reward than an alternative reward that this reward should be offered in preference to the others.

Once a series of action output modules have been created those that do not require action at the TARP client they are relayed to the TARP Server where the actions are processed.

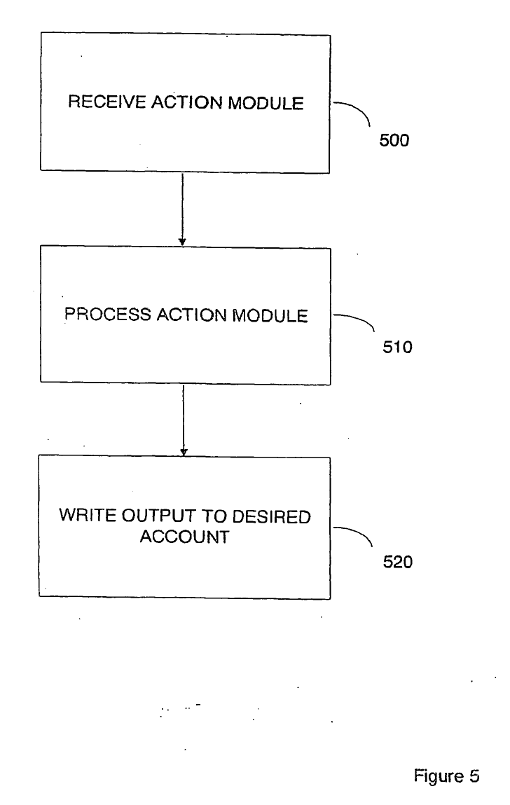

FIG. 5 is a process flow outlining a top level process flow at the TARP server. An action module is received from the TARP client over a network such as a wide area network (WAN) or local area network (LAN). (Step 500). The action module is then processed (Step 510) and on the basis of the output of the processing of the specific action module the result may be updated (Step 520) to one or more alternative networks.

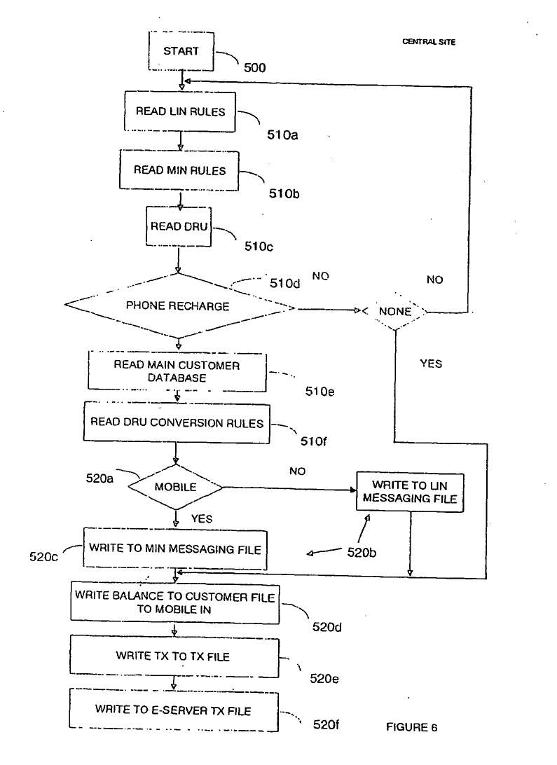

FIG. 6 is a detailed process associated with the processing of an action module associated with the incrementation of pre-paid telephone accounts from digital reward units. On receiving the action file and initiating the process (Step 500) the local parameters relating to land line intelligent (LIN) network communication protocols are loaded (Step 510a). Once this has been achieved the parameters relating to mobile intelligent network communication protocols (MIN) are loaded (Step 510b).

The digital reward unit file is then read from the specific customer related database (Step 510c); this store file indicates the current recharge or reward level for a particular customer. The action module is then interrogated to ascertain whether this specific action module relates to phone recharging (Step 510d). If it does not the process is terminated. If the action module relates to such a phone recharge, the main customer database is read (Step 510e) and used to load customer details. The DRU conversion rules are then read (Step 510f). With the MIN/LIN communications rules already loaded the system is now in a position to write messages to intelligent networks (Step 520b) instructing systems to increment balances relating to the specific phone accounts. The DRU balance is then written to the customer file (Step 520d), which is done so that a mirror image of the DRU balance is accessible by the customer on the TARP server. This enables the customer to examine his balance remotely, while also effecting the updating of the system relating to the actual phone charging. The transaction is then stored (Step 520e) and written to the e-server text file which allows subsequent review by the customer (Step 520f).

Although described above with reference to the incrementation of a customer associated mobile telephone account it will be appreciated by those skilled in the art that the system and method of the present invention are equally applicable to updating any number of electronically accessible accounts, including for example customer utility accounts such as gas, electricity or water. In such situations the action output modules are written such that when processed an incrementation is transferred to the specific customer account.

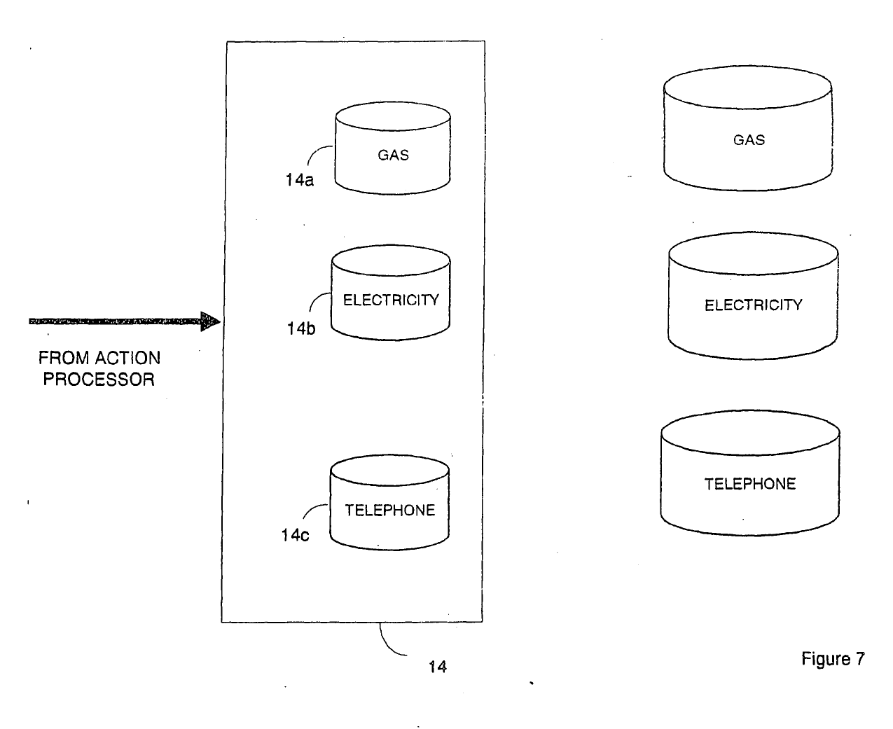

FIG. 7 shows in a schematic form, a portion of the internal structure of the TARP server wherein the specific customer account is associated with and activated for the payment of one or more utility accounts 14a, b, c. Once the transaction files have been processed by the action processor module 17 information relating to the updating of the specific customer utility accounts is transferred to the specific customer database profile. FIG. 7 is an example of three accounts being active for the user in question; gas 14a, electricity 14b, and telephone 14c. The updating of these accounts with reference to the incrementation associated with the transaction “reward” is stored and then is typically transferred in a batch manner to the central billing facilities of the specific utility in question. The system of the present invention is not intended to replace the existing billing system, rather it adopts the persona of a clearing house, receiving information from that the required funds have been input to the system—either in the format of a direct payment or as a result of a reward related to specific purchases, and then updating and transferring the funds to the relevant utility.

As described hereinbefore the system of the present invention monitors the kicker codes of specific transactions and effects a “reward” as a result of the processing of the transactions. This “reward” typically results from on-going promotions being sponsored by the specific manufacturers or retailers, with the remuneration that is transferred to the customer being reimbursed by the promoter. It will be appreciated that the system of the present invention is equally suited to a direct payment transfer at the EPOS device, and the definition of “reward” is intended to cover both promotional benefits arising from specific transactions and direct payments effected at the EPOS device. For example is a user wishes to transfer a specific payment to a utility account then at the EPOS device a specific kicker code associated with that utility is activated once the payment is made. The processing of the kicker code transaction by the TARP client/server simply updates the system of the present invention to increment the associated customer database as to the fact that a payment has been made and that the relevant utility account should be updated.

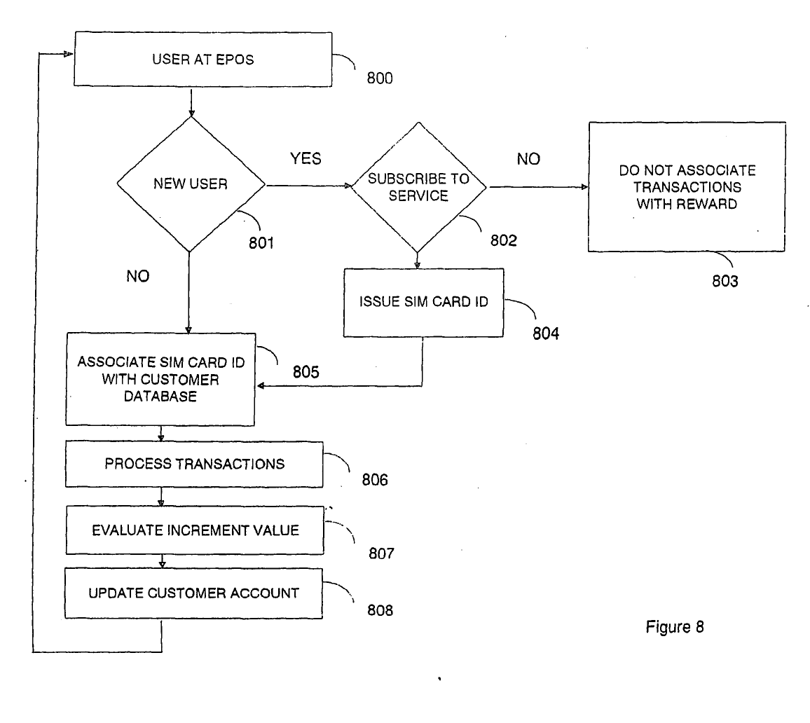

In preferred embodiments the system of the present invention will include the effecting of an increment to a mobile or cellular phone user based on the volume of transactions conducted by that user. FIG. 8 shows a process flow associated with the incrementation of the specific user account. The user presents at the EPOS device (Step 800) in a retail outlet. Using a magnetic swipe card or alternative interface the system of the present invention is interrogated as to whether the user is a subscribed user (Step 801). If the user is a new user, the user is prompted as to whether they wish to subscribe to the system of the present invention (Step 802). If there is no response in the affirmative then the normal series of transactions are continued (Step 803).

If the user wishes to use the system of the present invention a cellular telephone SIM card ID is issued to the customer and a customer profile is established relating to that SIM card ID on the system (Step 804). In all subsequent transactions the use of the SIM card ID relates the customer to his/her profile and allows the system of the present invention to increment the account as a result of the transactions conducted.

Once the customer or consumer is a subscribed user then any transactions conducted by the consumer at retail outlets using the system of the present invention will be associated with that customer (Step 805). The transactions are processed (Step 806), as described previously, with rewards being transferred (Step 808) to the customer account as a result of specific transactions being conducted (Step 807).

Although described with reference to the example of the customer physically presenting himself to the retail outlet it will be appreciated by those skilled in the art that the system and method of the present invention is also suitable for electronic shopping/transactions. In such situations the consumer will be prompted to enter User identifiers so as to associate the specific user with the system database of the present invention. It will also be appreciated that a user may subscribe to the system of the present invention remotely—for example using internet access to a website or portal—and have specific information relating to the customer account/profile transferred to him electronically.

It will also be appreciated that the processing of the action files of the present invention may also be adapted to effect the informing of the customer of specific promotions relating to the transactions being conducted. For example the processing of the kicker codes during the transaction at the TARP client 4 enable the system of the present invention to identify when specific promotional items have been purchased. If a specific product or a predetermined number of products have been purchased then the system may be prompted to inform the customer of specific promotions relating to that purchase sequence. For example it is known in retail outlets to analyse the kicker codes so that the till receipt can inform the customer of a particular number of transactions that have been purchased from a specific geographical region; the system of the present invention extends this functionality to effect a reward or information transfer on the till receipt relating to the purchases; for example “You have purchased X items of Brand Y, purchase X more within two weeks and they will be at 50% retail price.” This informing of the consumer of promotions may also be effected directly to the user mobile telephone or email account if these parameters are stored in the customer profile.

It will be further appreciated that although the present invention has been described with reference to a specific retail environment where the customer presents himself to the retailer and the actions are customer prompted that variances to this methodology are possible. For example, the skilled person will appreciate that a modification such as where the actions are retailer prompted is equally applicable and forms part of the present invention. Such an example is where a retailer, having established a customer loyalty database, wishes to effect a promotion. By selecting customers, based on their searchable criteria within the database, the retailer can effect a messaging service to specific customers informing them of new promotions or can simply update their account. Similarly, the system and method may be modified so as to be used in a general broker or vendor type environment as opposed to the specific retail environment herein described by way of example.

The present invention has been described with reference to a specific retail environment and it will be appreciated that this description is of an exemplary embodiment of the present invention and it is not intended to limit the present invention to such a retail environment. It will be appreciated that the system and computer implemented method of the present invention may be modified within the scope of the present invention to encompass variant environments that make use of an evolving database of users.

The words “comprises/comprising” and the words “having/including” when used herein with reference to the present invention are used to specify the presence of stated features, integers, steps or components but does not preclude the presence or addition of one or more other features, integers, steps, components or groups thereof.

1. A loyally reward system adapted to interface with transactions conducted by an identified customer at a retail outlet and to update that customer's profile or an associated digital account of that customer with credits depending on the volume and nature of the transactions conducted by the customer at the retail outlet, the system comprising:
a) means for identifying a customer at a retail outlet,
b) at least one transaction analysis and reaction process (TARP) client (4) including a data input processor and adapted to be in electronic communication with a data input recording device (2) so as to receive the same information received at the data input recording device (2) relating to on-going transactions being conducted by a customer at the device (2), the data input processor being adapted to:
i) receive details of individual sales item transactions and a sum of the individual sales items transactions conducted by the identified customer at the data input recording device (2);
ii) compare the identified customer with a stored database of customer profiles so as to determine whether the identified customer is a subscriber to the system, such that further analysis of the transactions is restricted to those customers that are subscribers:
iii) identify within the individual sales item transactions specific transactions relating to products on which analysis is to be conducted,
iv) process information relating to specific transactions into one or more action output modules having associated definable parameters relating to the customer profile and what action is to be conducted once the action modules are processed so as to effect predefined actions,
c) at least one action processor (17) adapted to electronically receive action output modules from one or more data input processors (4) and to process these action output modules according to their associated defined parameters so as to effect the updating of the associated digital account of the identified customer or to effect the transmittal of customer related information to the identified customer,
d) a transaction analysis and reaction process (RARP) server (6) including a client interface system, the TARP server (6) being remotely located from the TARP client (4) and being adapted to be in communication with one or more remotely locatable clients (10, 11), the interface system effecting communication between the TARP client (4) and the subscriber to the system so as to enable a subscriber to receive information relating to the specific action conducted and with regard to the results of the processed action output modules.

2. The loyalty system as claimed in claim 1 wherein the data input recording device (2) is an electronic point of sale (EPOS) device and the TARP client (4) is in communication with an EPOS server (3), the EPOS server (3) being in electronic communication with the electronic point of sale (EPOS) devices at the retail outlet, the TARP client (4) being updated with the same information of the transaction process that the EPOS server (3) is updated with from the EPOS devices (2), the data input processor of the TARP client (4) being adapted to receive information relating to specific retail transactions conducted by the identified customer at the retail outlet and to process this information into one or more action output modules, the action output modules having associated definable parameters so as to effect predefined actions.

3. The loyalty system as claimed in claim 2 wherein the retail transaction processor (17) is co-locable with the TARP client (4) and the electronic point of sale devices, the co-location enabling a real time communication between the retail transaction processor and the electronic point of sale devices so as to enable a formation of action output modules resulting from individual retail transactions and the formation of action output modules resulting from the total transaction conducted by a consumer at a retail outlet.

4. The loyalty system as claimed in claim 3 wherein the individual transactions are typically individual sale items whereas the total transaction represents the sum of the individual sale items.

5. The loyalty system as claimed in claim 4 or claim 3 wherein individual transaction action output modules are related to specific predetermined retail product transactions such that the purchase of specific retail products formulates an action output module which may effect a prompting of the customer with regard to specific promotions relating to that retail product.

6. The loyalty system as claimed in any preceding claim wherein at least one data input processor is co-locatable or embedded with the data input recording device so as to effect a processing of one or more action output modules concurrently with the actions that initiate the action/data input processor generation of action output modules relating to the specific action.

7. The loyalty system as claimed in claim 5 wherein the prompting of the customer may be effected in-store at the time of at the time of the initiating action or at a later date, such that where the prompting is conducted at the time of the initiating action, the action output module associated with that prompting is processed at the TARP client (4); and where the there is no prompting required at the time of the initiation action, that the action output module is processed at the TARP server (6).

8. The loyalty system as claimed in any preceding claim wherein the individual action output modules are related to a monetary payment effected by a consumer at the action/data input recording device and the processing of the action output modules effects an incrementation of a digital account of that consumer.

9. The loyalty system as claimed in claim 8 wherein the digital account is selected from one or more of the following:
a) a pre-paid mobile telephone account,
b) a pre-paid land line telephone account,
c) a prepaid or post-paid utility account relating to one or more utilities,
d) an electronic purse.

10. The system as claimed in any preceding claim wherein at least one action processor is located remotely from the TARP client, the action output modules being transferred from the TARP client to the action processor located with the TARP server in a pre-processed format.

11. The loyalty system as claimed in any preceding claim wherein the processing of action output modules effects a creation of digital reward units, the number of digital reward units being related to the total value of the transaction conducted.

12. The loyalty system as claimed in claim 11 wherein the digital reward units are incremented against a digital account of the specific user, the incrementation being effected by the action/data input processing server.

13. A computer implemented method of updating a user profile electronic account, the method comprising the steps of:
a) identifying, using an inputted customer identifier, a specific user profile electronic account relating to the customer conducting the transaction,
b) analysing the transactions conducted by the customer at an electronic point of sale (EPOS) device, details of the transaction process being updated from the EPOS device to a TARP client (4) for analysis at the TARP client,
c) associating one or more pre-defined transactions with a specific increment value so as to generate an action output module, the action output module having associated parameters relating to the customer profile and what action is to be conducted once the action output modules are processed,
d) processing the action output module so as to effect an updating of the customer's electronic account, and
wherein the processing of the action output module is effected concurrently with the transaction being conducted by the customer, and the updating of the customer's electronic account is effected by a TARP server (6) remote from the TARP client (4).

14. The method as claimed in claim 13 wherein the steps of identifying a specific user profile electronic account comprises the steps of:
a) electronically reading a customer identifier supplied by the customer, and
b) associating the customer identifier with a pre-defined customer user profile located in a customer database.

15. The method as claimed in any one of claims 13 or 14 wherein the steps of identifying the user profile, analysing the actions and generating of the action output modules is conducted at the vendors premises where the transactions are being effected.

16. The method as claimed in any one of claims 13 to 15 wherein the processing of at least one action output module is conducted at the vendors/brokers premises.

17. The method as claimed in any one of claims 13 to 16 wherein the user profile electronic account may be subdivided into two or more specific accounts, the processing of the action output module incrementing one or more of the specific accounts in accordance with parameters associated with the action output module.

18. The method as claimed in any one of claims 13 to 17 wherein the processing of an action output module effects a transmittal of information to the specific customer, the information being related to the transaction that effected the formation of the action output module.

19. The method as claimed in claim 18 wherein the transmittal of information is activated concurrently with the transaction being conducted by the customer.

20. The method as claimed in any one of claims 13 to 19 wherein the incrementation of a user profile electronic account effects an incrementation of a user telephone account, the value of the increment being related to the value of the transactions conducted by the user.

21. The method as claimed in claim 20 wherein the customer identifier is a SIM card ID associated with the specific customer and the incrementation of the user telephone account increments the cellular telephone associated with that SIM card ID.
